(19) United States
(12) Patent Application Publication
(10) Pub. No.: US 2026/0112786 A1
(43) Pub. Date: Apr. 23, 2026

(54) BATTERY CELL AND PROCESS FOR FORMING THE SAME

(71) Applicants: ZHEJIANG JINKO ENERGY STORAGE CO., LTD., Haining City (CN); Jinko Energy Storage Technology Co., Ltd., Haining City (CN)

(72) Inventors: Xianrong ZENG, Haining City (CN); Yuhao WU, Haining City (CN); Zixiang YANG, Haining City (CN); Tianjun XIA, Haining City (CN)

(73) Assignees: ZHEJIANG JINKO ENERGY STORAGE CO., LTD., Haining City (CN); Jinko Energy Storage Technology Co., Ltd., Haining City (CN)

(21) Appl. No.: 18/962,145

(22) Filed: Nov. 27, 2024

(30) Foreign Application Priority Data
Oct. 23, 2024 (CN) 202411480349.X
Oct. 23, 2024 (CN) 202411491485.9

(51) Int. Cl. H01M 50/531; H01M 50/103; H01M 50/15; H01M 50/159; H01M 50/188; H01M 50/586

(52) U.S. Cl. CPC H01M 50/531; H01M 50/103; H01M 50/15; H01M 50/159; H01M 50/188; H01M 50/586

(57) ABSTRACT

A battery cell and a process for forming the same. The battery cell includes a top cover structure including a pole including a main body, first bending portions and second bending portions; a bare aluminum sheet; and a connecting sheet. The first and second bending portions are arranged at two sides of the main body, and extend horizontally along a width direction. The first bending portion and the second bending portion projected on a same straight line along the width direction extend oppositely in the width direction. Two adjacent first or second bending portions arranged along a length direction bend oppositely in the width direction. A ratio of a length of the pole to a length of the battery cell is greater than or equal to 10%. The connecting sheet is provided with staggered first connecting holes. The second bending portions are buckled in the first connecting holes.

### CROSS-REFERENCE TO RELATED APPLICATIONS

This application claims priority to Chinese Application No. 202411491485.9, and Chinese Application No. 202411480349.X, both of which were filed on Oct. 23, 2024, and the contents of which are incorporated herein by reference in their entireties.

### FIELD

The present disclosure relates to the field of energy storage technology, and in particular, to a battery cell and a process for forming the same.

### BACKGROUND

The statements in this section merely provide background information related to the present disclosure and may not constitute prior art.

The battery cell includes a top cover structure, which includes a pole and a connecting sheet. The top cover structure is connected to a cell component inside a shell through the cooperation of the pole and the connecting sheet. The pole is a key component that connects an internal electrode of the battery cell with an external circuit, and has functions such as electrical connection, current carrying, thermal management, and mechanical fixation. With the increase of battery cell capacity, large-capacity batteries need to carry a large current during charging and discharging. In order to ensure that the current can pass through the pole stably, a large-sized pole is required to reduce contact resistance and improve current carrying capacity.

However, when the battery cell uses a large-sized pole, the large-sized pole and the connecting sheet are welded along a circumferential edge of the pole, and the connection stability between the two is poor, which is easy to affect the output voltage and efficiency of the battery cell.

### SUMMARY

This section provides a general summary of the disclosure and is not a comprehensive disclosure of its full scope or all of its features.

In view of the above, the present disclosure provides a battery cell and a process for forming the same. The battery cell adopts a pole having a large-sized structure, and the pole is provided with first bending portions and second bending portions, and the second bending portions are buckled into a connecting sheet to improve the current carrying capacity of the pole while ensuring the connection stability between the pole and the connecting sheet.

In a first aspect, an embodiment of the present disclosure provides a battery cell including a top cover structure, and the top cover structure includes a pole including: a main body, first bending portions, and second bending portions, wherein the first bending portions and the second bending portions are respectively arranged at two sides of the main body along a height direction of the battery cell, and the first bending portions and the second bending portions each extend horizontally along a width direction of the battery cell; the first bending portion and the second bending portion that are projected on a same straight line along the width direction of the battery cell extend oppositely in the width direction of the battery cell; two adjacent first bending portions arranged along a length direction of the battery cell bend oppositely in the width direction of the battery cell, and two adjacent second bending portions arranged along the length direction of the battery cell bend oppositely in the width direction of the battery cell; and a ratio of a length of the pole to a length of the battery cell is greater than or equal to 10%; a bare aluminum sheet provided with a mounting hole, wherein the main body of the pole is inserted in the mounting hole, and the first bending portions and the second bending portions are respectively located at two sides of the mounting hole along the height direction of the battery cell; and a connecting sheet provided with first connecting holes staggered from one another, wherein the second bending portions of the pole are buckled in the first connecting holes, and the second bending portions do not protrude from a surface of the connecting sheet away from the bare aluminum sheet.

In some embodiments, the length of the pole ranges from 10 mm to 100 mm along the length direction of the battery cell.

In some embodiments, the first bending portions and the second bending portions each have a length ranging from 1 mm to 10 mm along the length direction of the battery cell.

In some embodiments, the first bending portions and the second bending portions each have an extension length ranging from 0.5 mm to 5 mm along the width direction of the battery cell.

In some embodiments, along the length direction of the battery cell, a space between two adjacent first bending portions ranges from 0.17 mm to 3.4 mm, and a space between two adjacent second bending portions ranges from 0.17 mm to 3.4 mm.

In some embodiments, the connecting sheet and the second bending portions are welded together after the second bending portions are buckled in the connecting sheet.

In some embodiments, the ratio of the length of the pole to the length of the battery cell is smaller than or equal to 30%.

In some embodiments, in each of the length direction of the battery cell, the width direction of the battery cell, and the height direction of the battery cell, the first bending portions and the second bending portions are staggered from one another.

The battery cell also includes a cell component, a shell, and an insulating film. The top cover structure is connected to a top of the shell, the cell component is accommodated in the shell, and the top cover structure includes a bottom surface having a connecting region, wherein a distance between the connecting region and a center of the bottom surface of the top cover structure is smaller than a distance between an edge of the top cover structure and the center of the bottom surface of the top cover structure. The insulating film includes a film body coated on a side wall and a bottom wall of the cell component, and extending portions formed by extending upwards from side walls of the film body, wherein the extending portions are bent towards a center of a top surface of the cell component along a length direction and a width direction of the cell component, and the extending portions are located between the connecting region and the top surface of the cell component along the height direction of the cell component, and an upper surface of the extending portions is connected to a lower surface of the connecting region.

In some embodiments, the extending portions includes first extending portions arranged oppositely along the width direction of the battery cell and second extending portions arranged oppositely along the length direction of the battery cell. The bottom surface of the top cover structure is provided with first regions arranged oppositely along the width direction of the battery cell and second regions arranged oppositely along the length direction of the battery cell; when installing the insulating film, the first extending portion is located between the first region and the top surface of the cell component, and the upper surface of the first extending portion is connected to the first region; the second extending portion is located between the second region and the top surface of the cell component, and an upper surface of the second extending portion is connected to the second region.

In some embodiments, the first extending portions each have a width ranging from 2 mm to 8 mm, and the second extending portions each have a width ranging from 2 mm to 6 mm.

In some embodiments, the first region includes a first sub-region, the second region includes a second sub-region, the first sub-region overlaps with the second sub-region, the first extending portion is located between the top surface of the cell component and other sub-regions of the first region except the first sub-region, and the second extending portion is located between the top surface of the cell component and other sub-regions of the second region except the second sub-region.

In some embodiments, the cell component includes a top wall, a bottom wall, a left side wall, a right side wall, a front side wall, and a rear side wall, wherein the top wall and the bottom wall are opposite to each the along the height direction of the cell component, the left side wall and the right side wall are opposite to each other along the length direction of the cell component, and the front side wall and the rear side wall are opposite to each other along the width direction of the cell component; and the insulating film includes a first portion and a second portion that have a same structure. The battery cell is divided along a center line of the battery cell, the first portion covers the rear side wall, a part of the top wall, a part of the left side wall, a part of the right side wall, and a part of the bottom wall of the cell component; the second portion covers the front side wall, a part of the top wall, another part of the left side wall, another part of the right side wall, and another part of the bottom wall of the cell component; and the film body of the first portion and the film body of the second portion partially overlap with each other at the top wall, at the bottom wall, at the left side wall and at the right side wall of the cell component.

In some embodiments, the top cover structure further includes: a bare aluminum sheet provided with a mounting hole, wherein the pole is inserted into the mounting hole, and at least part of a wall surface of the mounting hole is an inclined surface; a connecting sheet connected to a bottom of the pole; and a sealing ring sleeved on an outer periphery of the pole and inserted into the mounting hole of the bare aluminum sheet to abut against the inclined surface where the mounting hole is located.

In some embodiments, the top cover structure further includes a support assembly, wherein the support assembly includes a first pressing block and a second pressing block, wherein the sealing ring is arranged between the first pressing block and the second pressing block along a thickness direction of the sealing ring.

In a second aspect, the present disclosure provides a process for forming a battery cell, the battery cell includes a top cover structure, and the top cover structure includes: a pole including a main body, first bending portions, and second bending portions, wherein the first bending portions and the second bending portions are respectively arranged at two sides of the main body along a height direction of the battery cell, and the first bending portions and the second bending portions each extend horizontally along a width direction of the battery cell; the first bending portion and the second bending portion that are projected on a same straight line along the width direction of the battery cell extend oppositely in the width direction of the battery cell; two adjacent first bending portions arranged along a length direction of the battery cell bend oppositely in the width direction of the battery cell, and two adjacent second bending portions arranged along the length direction of the battery cell bend oppositely in the width direction of the battery cell; and a ratio of a length of the pole to a length of the battery cell is greater than or equal to 10%; a bare aluminum sheet provided with a mounting hole, wherein the main body of the pole is inserted in the mounting hole, and the first bending portions and the second bending portions are respectively located at two sides of the mounting hole along the height direction of the battery cell; and a connecting sheet provided with first connecting holes staggered from one another, wherein the second bending portions of the pole are buckled in the first connecting holes, and the second bending portions do not protrude from a surface of the connecting sheet away from the bare aluminum sheet. The process for forming the battery cell includes a process for assembling the top cover structure, and the process for assembling the top cover structure includes: providing the pole, the bare aluminum sheet, and the connecting sheet, wherein the pole includes the main body, first extending portions, and second extending portions, wherein the first extending portions and the second extending portions are respectively arranged at two sides of the main body along the height direction of the battery cell, the bare aluminum sheet is provided with the mounting hole, and the connecting sheet is provided with the first connecting holes staggered from one another; inserting the main body of the pole into the mounting hole of the bare aluminum sheet, bending the first extending portions to form the first bending portions, and bending the second extending portions to form the second bending portions, wherein the first bending portion and the second bending portion bend oppositely in the width direction of the battery cell; and along the length direction of the battery cell, two adjacent first bending portions arranged along the length direction of the battery cell bend oppositely in the width direction of the battery cell, and two adjacent second bending portions arranged along the length direction of the battery cell bend oppositely in the width direction of the battery cell; and buckling the second bending portions of the pole into the first connecting holes of the connecting sheet, wherein the second bending portions do not protrude from the surface of the connecting sheet away from the bare aluminum sheet.

In some embodiments, the process for forming the battery cell further includes: welding the second bending portions of the pole with edges of the first connecting holes of the connecting sheet.

In some embodiments, the battery cell further includes: a cell component; a shell, wherein the top cover structure is connected to a top of the shell, the cell component is accommodated in the shell, and the top cover structure includes a bottom surface having a connecting region, wherein a distance between the connecting region and a center of the bottom surface of the top cover structure is smaller than a distance between an edge of the top cover structure and the center of the bottom surface of the top cover structure; and an insulating film, wherein the insulating film includes a film body coated on a side wall and a bottom wall of the cell component, and extending portions formed by extending upwards from side walls of the film body, wherein the extending portions are bent towards a center of a top surface of the cell component along a length direction and a width direction of the cell component, and the extending portions are located between the connecting region and the top surface of the cell component along the height direction of the cell component, and an upper surface of the extending portions is connected to a lower surface of the connecting region. The process for forming the battery cell includes: a coating process of an insulating film, and the coating process of the insulating film includes: providing the cell component, the top cover structure, and the insulating film, wherein the cell component includes a top wall, a bottom wall, a left side wall, a right side wall, a front side wall, and a rear side wall, wherein the top cover structure includes a bottom having a connecting region, wherein a distance between the connecting region and a center of the top cover structure is smaller than a distance between an edge of the top cover structure and the center of the top cover structure; the battery cell further includes the insulating film, wherein the insulating film includes a first portion and a second portion that have a same structure and each are provided with the film body and the extending portion; coating, by the first portion and the second portion, the cell component along the width direction of the cell component, wherein the film body of the first portion coats the rear side wall, a part of the top wall, a part of the left side wall, a part of the right side wall, and a part of the bottom wall of the cell component; the film body of the second portion covers the front side wall, a part of the top wall, another part of the left side wall, another part of the right side wall, and another part of the bottom wall of the cell component; and a part of the film body of the first portion and a part of the film body of the second portion overlap with each other at the bottom wall, at the left side wall, and at the right side wall of the cell component; and bending the extending portions of the first portion and the second portion towards a center of the top surface of the cell component along each of the length direction and the width direction of the cell component, in such a manner that the extending portions are located between the connecting region and the top surface of the cell component and upper surfaces of the extending portions are connected to the connecting region.

In some embodiments, at least part of a wall surface of the mounting hole is an inclined surface, and the process for forming the battery cell further includes a process for installing a sealing ring. The process for installing the sealing ring includes: providing the sealing ring, a first pressing block, and a second pressing block; and sleeving the sealing ring, the first pressing block and the second pressing block on an outer periphery of the pole, wherein the first pressing block, the sealing ring and the second pressing block are stacked along a height direction of the pole; and inserting the sealing ring into the mounting hole of the bare aluminum sheet, in such a manner that the sealing ring abuts against the inclined surface where the mounting hole is located, wherein the first pressing block and the second pressing block apply a force on the sealing ring in such a manner that the sealing ring fills a gap formed between a wall surface of the mounting hole, the pole, the first pressing block, and the second pressing block.

In some embodiments, the extending portions and the connecting region of the top cover are connected together by hot melting.

The above-described technical solutions have at least the following beneficial effects.

In the battery cell of the present disclosure, the ratio of the length of the pole to the length of the battery cell is greater than or equal to 10%, that is, the pole is of a large size, and the large-sized pole has high mechanical strength, a low contact resistance, and great current carrying capacity, and the large-sized pole has better heat dissipation performance, which can ensure that the battery cell operates within a safe temperature range. At the same time, the pole is provided with second bending portions, and two adjacent second bending portions arranged along the length direction of the battery cell bend oppositely in the width direction of the battery cell, and the connecting sheet includes connecting holes staggered from one another. When assembling the battery cell, the second bending portions of the pole can be buckled in the connecting holes to ensure the connection stability between the pole and the connecting sheet.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an explosive view of a battery cell provided by an embodiment of the present disclosure;

FIG. 2 is a schematic diagram of a top surface of a top cover structure of a battery cell provided by an embodiment of the present disclosure;

FIG. 3 is a cross-sectional view of a top cover structure of a battery cell provided by an embodiment of the present disclosure;

FIG. 4 is a partial explosive view of a top cover structure of a battery cell provided by an embodiment of the present disclosure;

FIG. 5 is a schematic diagram of an insulating film of a battery cell provided by an embodiment of the present disclosure;

FIG. 6 is a schematic diagram of a connecting sheet of a battery cell provided by an embodiment of the present disclosure;

FIG. 7 is a schematic diagram of a bare aluminum sheet of a battery cell provided by an embodiment of the present disclosure;

FIG. 8 is a schematic diagram of an insulating sheet of a battery cell provided by an embodiment of the present disclosure;

FIG. 9 is a schematic diagram of a sealing ring of a battery cell provided by an embodiment of the present disclosure;

FIG. 10 is a schematic diagram of a first pressing block of a battery cell provided by an embodiment of the present disclosure;

FIG. 11 is a schematic diagram of a second pressing block of a battery cell provided by an embodiment of the present disclosure;

FIG. 12 is a schematic diagram of a second pressing block of a battery cell provided by an embodiment of the present disclosure from another viewing angle;

FIG. 13 is a schematic diagram of a pole of a battery cell provided by an embodiment of the present disclosure;

FIG. 14 is a cross-sectional view of a top cover structure of a battery cell provided by an embodiment of the present disclosure; and

FIG. 15 is a schematic diagram of a bar of a battery cell provided by an embodiment of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In order to better understand the technical solution of the present disclosure, the embodiments of the present disclosure are described in detail in combination with the accompanying drawings.

It should be clear that the described embodiments are only some embodiments of the present disclosure, rather than all embodiments. Based on the embodiments in the present disclosure, all other embodiments obtained by ordinary technicians in the field without creative work are within the scope of protection of the present disclosure.

The terms used in the embodiments of the present disclosure are only for the purpose of describing specific embodiments, and are not intended to limit the present disclosure. The singular forms of “a”, “said” and “the” used in the embodiments of the present disclosure and the attached claims are also intended to include plural forms, unless the context clearly indicates other meanings.

It should be understood that the term “and/or” used in this article is only a description of the association relationship of the associated objects, indicating that there can be three relationships, for example, A and/or B can represent: A alone, A and B, and B alone. In addition, the character “/” in this article generally indicates that the related objects before and after are in an “or” relationship.

It should be noted that the directional words such as “up”, “down”, “left”, and “right” described in the embodiments of the present disclosure are described at the angles shown in the accompanying drawings and should not be understood as limitations on the embodiments of the present disclosure. In addition, in the context, it is also necessary to understand that when it is mentioned that an element is connected to another element “above” or “below”, it can not only be directly connected to another element “above” or “below”, but also indirectly connected to another element “above” or “below” through an intermediate element.

In the battery cell of the energy storage device, the top cover structure is connected to the cell component inside the shell through the cooperation of the pole and the connecting sheet, and the pole is a key component connecting an internal electrode of the battery cell with an external circuit, and has functions such as electrical connection, current carrying, thermal management, and mechanical fixation.

With the increase of battery cell capacity, large-capacity batteries need to carry a larger current during charging and discharging. In order to ensure that the current can stably pass through the pole, a large-sized pole is required to reduce the contact resistance and improve the current carrying capacity. However, when the battery cell adopts a large-sized pole, the large-sized pole and the connecting sheet are welded along a circumferential edge of the pole, and the connection stability between the two is poor, which is easy to affect the output voltage and efficiency of the battery cell.

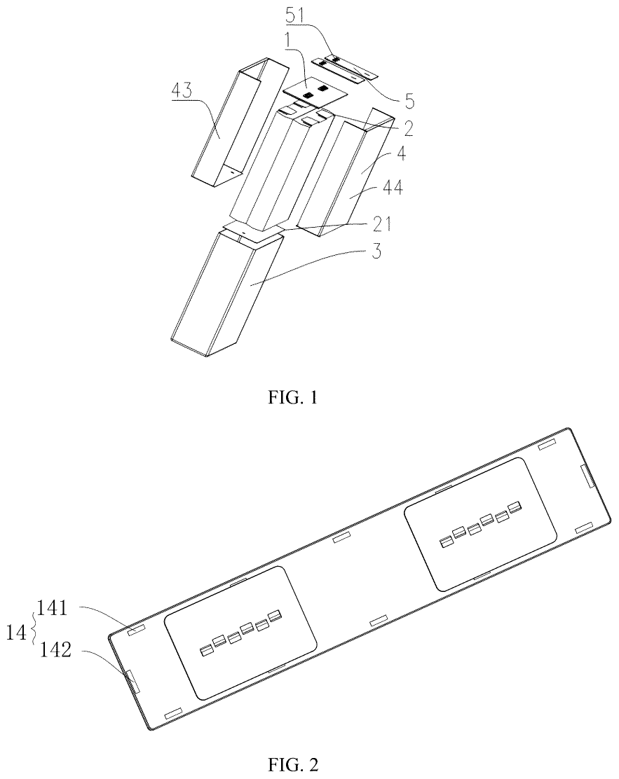

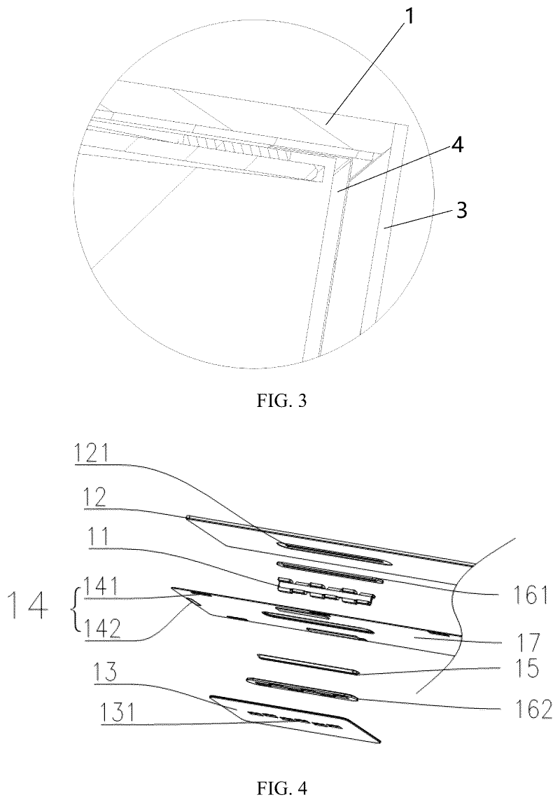

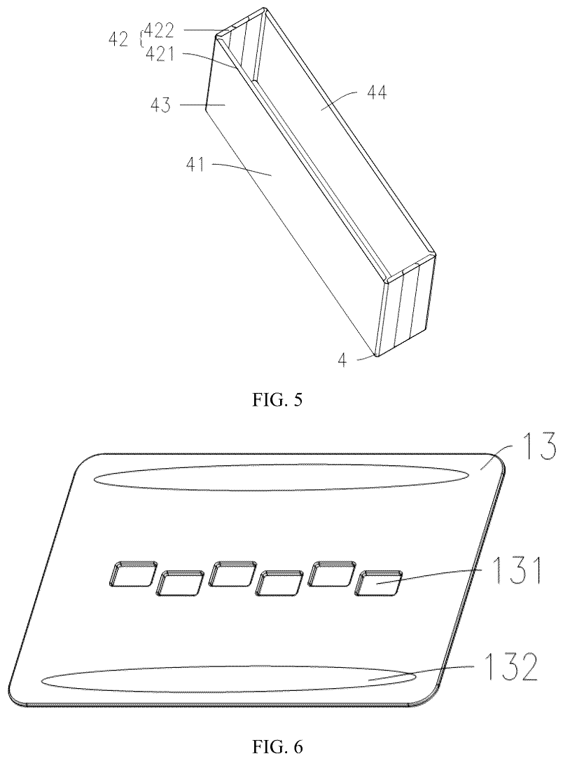

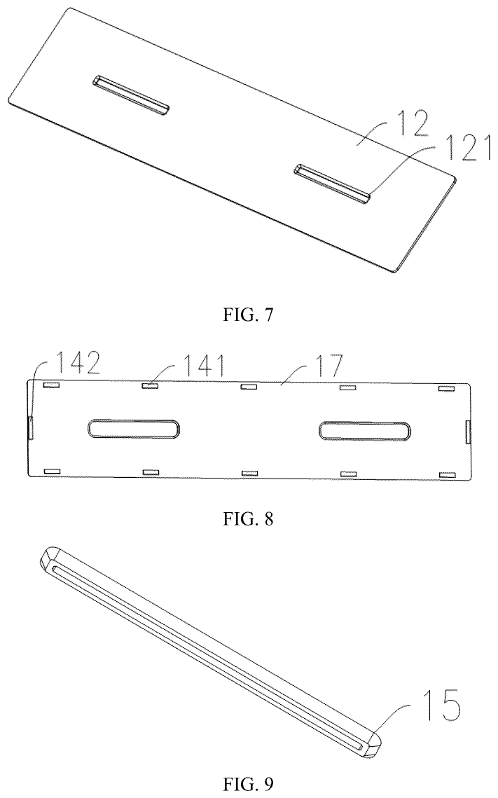

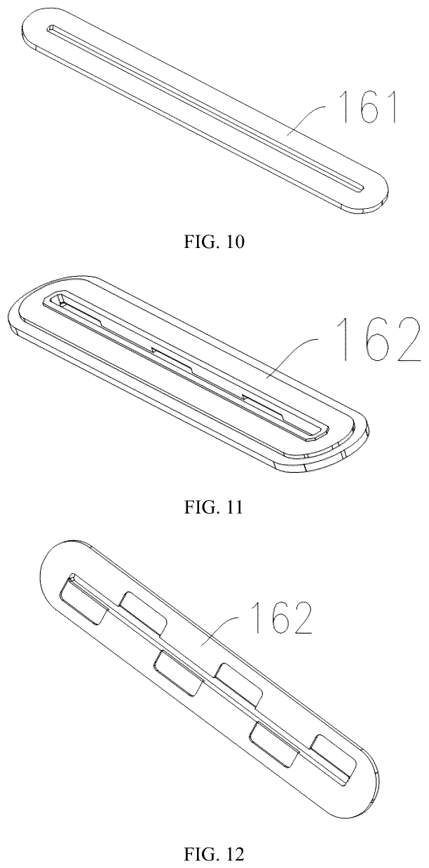

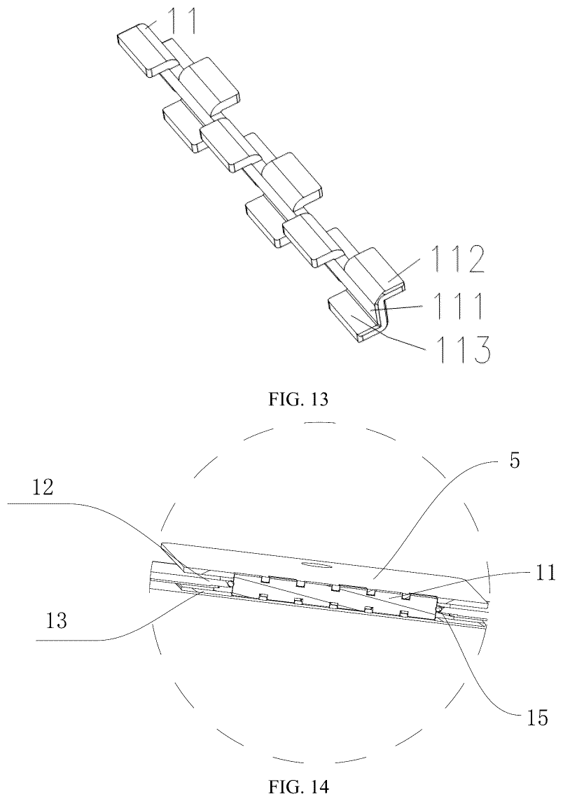

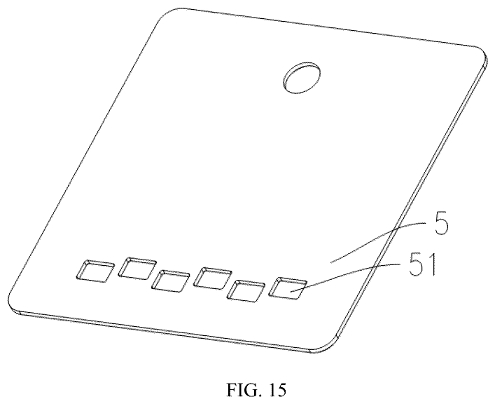

In view of the above, an embodiment of the present disclosure provides a battery cell including a top cover structure 1. Referring to FIG. 1 to FIG. 15, the top cover structure 1 includes a pole 11, a bare aluminum sheet 12, and a connecting sheet 13.

The pole 11 includes a main body 111, a first bending portion 112, and a second bending portion 113. Along a height direction of the battery cell, the first bending portion 112 and the second bending portion 113 are respectively arranged at two sides of the main body 111, and each extend horizontally along a width direction of the battery cell. Along the width direction of the battery cell, the first bending portion 112 and the second bending portion 113 that are projected on a same straight line extend oppositely in the width direction of the battery cell. Two adjacent first bending portions 112 arranged along a length direction of the battery cell bend oppositely in the width direction of the battery cell, and two adjacent second bending portions 113 arranged along the length direction of the battery cell bend oppositely in the width direction of the battery cell. A ratio of a length of the pole 11 to the length of the battery cell is greater than or equal to 10%.

The bare aluminum sheet 12 is provided with a mounting hole 121, the main body 111 of the pole 11 is inserted in the mounting hole 121, and along the height direction of the battery cell, the first bending portions 112 and the second bending portions 113 are located at two sides of the mounting hole 121.

The connecting sheet 13 is provided with first connecting holes 131 staggered from one another, the second bending portions 113 of the pole 11 are buckled in the first connecting holes 131, and the second bending portions 113 do not protrude from a surface of the connecting sheet 13 away from the bare aluminum sheet 12.

In the above-described solutions, in the battery cell of the present disclosure, the ratio of the length of the pole 11 to the length of the battery cell is greater than or equal to 10%, and further, the ratio of a total length of a positive pole and a negative pole to the length of the battery cell is greater than or equal to 10%, that is, the pole 11 has a large size, and the large-sized pole 11 has higher mechanical strength, lower contact resistance, and greater current carrying capacity. In addition, the large-sized pole 11 has better heat dissipation performance, which can ensure that the battery cell operates within a safe temperature range. At the same time, the pole 11 includes the second bending portions 113, two adjacent second bending portions 113 arranged along the length direction of the battery cell bend oppositely in the width direction of the battery cell, and the connecting sheet 13 includes first connecting holes 131 staggered from one another. In this case, when assembling the battery cell, the second bending portions 113 of the pole 11 can be buckled in the first connecting holes 131 to ensure a stable connection between the pole 11 and the connecting sheet 13.

In some embodiments, a battery pack, a battery management system, an energy storage converter are assembled to obtain an energy storage device. The energy storage device is configured to store and release electrical energy. The battery pack is configured to provide stable power output, the battery management system (BMS) is a key component configured to monitor, control and protect the operating status of the battery pack, such as a voltage, a current, a temperature and other parameters of each battery cell in the battery pack, and is configured to balance charging and control the charging and discharging process to protect the battery pack from damage such as overcharging, over-discharging, overheating, and short circuit, thereby extending the life of the battery pack and ensuring the safe and stable operation of the entire energy storage system. The power conversion system (PCS) is one of the core components of the energy storage system, and is configured to convert direct current (DC) to alternating current (AC) or converting alternating current to direct current to achieve the storage and release of electrical energy. The energy management system (EMS) is a key component configured to monitor, control, and optimize the overall performance of the energy storage system, and is configured to manage the energy exchange between the energy storage system and the power grid to ensure the efficiency, economy and safety of the system operation.

In addition to the above-mentioned structure, the energy storage device also includes an electrical system and a thermal management system, the electrical system includes all electrical components and circuits inside the energy storage device, such as series and parallel connections between battery cells, interfaces with inverters or chargers, connection devices with power grids or loads, control circuits, etc. The electrical system ensures efficient power conversion and transmission between the energy storage device and external power sources or loads. The thermal management system is a key system to ensure that the battery pack operates within a suitable temperature range and monitors and controls the internal temperature of the battery pack through components such as radiators, coolants, fans, and thermistors. When the battery generates heat during charging and discharging, the thermal management system can dissipate heat in a timely and effective manner to prevent the battery from overheating and causing performance degradation or safety problems.

The battery pack for providing a stable power output includes battery cells connected in series, in parallel, or in series and in parallel. The series connection between the battery cells can increase the total voltage of the battery pack, and the parallel connection between battery cells can increase the total capacity of the battery pack. The arrangement manner of the battery cells can be selected according to the voltage and capacity requirements of the battery pack, which is not limited herein.

In some embodiments, the battery cell generally includes a top cover structure 1, a cell component 2, and a shell 3. The cell component 2 is a core component of the battery cell, is configured to store and release electric energy, and usually includes a positive electrode material, a negative electrode material, electrolyte, and a diaphragm. The shell 3 is an external package of the battery cell and usually made of a material such as metal or plastic, and can provide physical protection to prevent the internal cell component 2 from being mechanically damaged, and at the same time can isolate the internal cell component 2 from the external environment to prevent moisture from intruding. The top cover structure 1 is configured to connect the cell component 2 with the external circuit and to provide a certain protection. During the production and assembly process, the cell component 2 is placed inside the shell 3 and fixed to the bottom of the shell 3 by screws, buckles and other fixing devices, and the top cover structure 1 is connected to the top of the shell 3 by welding, bolting or other methods, thereby obtaining the battery cell through assembling.

A bottom surface of the top cover structure 1 has a connecting region 14, that is, a bottom of a lower plastic of the top cover structure 1 has a connecting region 14, and a distance between the connecting region 14 and a center of the bottom surface of the top cover structure 1 is smaller than a distance between an edge of the top cover structure 1 and the center of the bottom surface of the top cover structure 1. For example, the connecting region 14 is arranged at a certain distance from the top cover structure 1. The connecting region 14 is an annular portion arranged on the inner side of the lower plastic, specifically including first regions 141 arranged oppositely along the width direction of the battery cell and second regions 142 arranged oppositely along the length direction of the battery cell. The first region 141 and the second region 142 overlap with each other at a corner region close to the lower plastic. In the present disclosure, the width of the first region 141, the width of the second region 142, and a distance between an annular portion and the edge of the lower plastic can be selected according to actual needs and are not limited herein.

The battery cell also includes an insulating film 4 wrapped around the outside of the cell component 2 and includes a film body 41 and an extending portion 42. The film body 41 is wrapped around a side wall and a bottom wall of the cell component 2. The extending portion 42 is formed by extending upward from the side wall of the film body 41, and is bent towards a center of a top surface of the cell component 2 along a length direction and a width direction of the cell component 2. The extending portion 42 is located between the connecting region 14 and the top surface of the cell component 2 along a height direction of the cell component 2, and an upper surface of the extending portion 42 is connected to a lower surface of the connecting region 14. It can be understood that the main body 111 encloses to form a rectangular box having a receiving cavity, and the cell component 2 is received in the rectangular box, and a top of the cell component 2 is flush with a top of the rectangular box, and in this case, the extending portion 42 is bent to complete the coating process of the cell component 2.

The extending portions 42 include first extending portions 421 oppositely arranged in the width direction of the battery cell, and second extending portions 422 oppositely arranged in the length direction of the battery cell. When the cell component 2 coated with the insulating film 4 is assembled with the shell 3 and the top cover structure 1, the first extending portion 421 is located between the first region 141 and the top surface of the cell component 2, and the upper surface of the first extending portion 421 is connected to the first region 141; and the second extending portion 422 is located between the second region 142 and the top surface of the cell component 2, and the upper surface of the second extending portion 422 is connected to the second region 142.

A width of the first extending portion 421 ranges from 2 mm to 8 mm, a width of the second extending portion 422 ranges from 2 mm to 6 mm, and the width of the first extending portion 421 is greater than the width of the second extending portion 422. Optionally, the width of the first extending portion 421 can range from 2 mm to 8 mm, 3 mm to 7 mm, 4 mm to 8 mm, or 5 mm to 6 mm, etc., specifically can be 2 mm, 3 mm, 4 mm, 5 mm, 6 mm, 7 mm and 8 mm, etc., or other values within this range, which can be selected according to actual needs and is not limited herein. The width of the second extending portion 422 can range from 2 mm to 6 mm, 3 mm to 5 mm, 2 mm to 5 mm or 4 mm to 4.5 mm, etc., specifically can be 2 mm, 3 mm, 4 mm, 5 mm and 6 mm, etc., or other values within this range, which can be selected according to actual needs and is not limited herein. It can be understood that the width of the first extending portion 42 and the width of the second extending portion 42 range within the above-mentioned ranges. When these two are bent inwards, a larger connecting region connecting with the first region 141 and the second region 142 can be formed, thus, it can improve the connection stability between the insulating film 4 and the connecting region 14, and will not affect the electrical connection between the connecting sheet 13 and the cell component 2 in the subsequent assembly process due to the excessively covering the top wall of the cell component 2. At the same time, the length of the battery cell is greater than the width of the battery cell, so that connection strength between the first extending portion 421 and the first region 141 is greater than connection strength between the second extending portion 422 and the second region 142, which can ensure the stable installation of the insulating film 4.

It should be noted that the first region 141 and the second region 142 have an overlapping portion. If an insulating film 4 is provided at the overlapping portion, the insulating film 4 stacked on the overlapping portion of the first region 141 and the second region 142 includes an upper portion and a lower portion. The lower portion of the insulating film 4 is not easy to be welded with the connecting region 14, which affects the connection between the insulating film 4 and the connecting region 14. Therefore, in the present disclosure, no insulating film 4 is provided at the overlapping portion of the first region 141 and the second region 142 to ensure the connection stability between the insulating film and the first region 141 and the second region 142. Specifically, the first region 141 includes a first sub-region, the second region 142 includes a second sub-region, the first sub-region overlaps with the second sub-region, the first extending portion 421 is located between the top surface of the cell component 2 and other sub-regions of the first region 141 except the first sub-region, and the second extending portion 422 is located between the top surface of the cell component 2 and other sub-regions of the second region 142 except the second sub-region.

The insulating film 4 of the above-mentioned coating structure can be a single complete insulating film 4 which covers the outside of the cell component 2, that is, the film body 41 and the extending portion 42 are formed into one piece. Or, multiple incomplete insulating films 4 may be combined together to cover the outside of the cell component 2, that is, the film body 41 or the extending portions 42 are formed by multiple film structures. It can be understood that the insulating film 4 having separate structures can be replaced when part of it is damaged during the assembly process, without needing to replace the entire insulating film 4, thereby reducing the assembly cost.

In some embodiments, the insulating film 4 of the present disclosure includes two parts. Specifically, the insulating film 4 includes a first portion 43 and a second portion 44 that have a same structure, and the first portion 43 and the second portion 44 each include the film body 41 and the extending portion 42, the first portion 43 and the second portion 44 each include second extending portions 422 arranged opposite to each other along the length direction of the battery cell and also include a first extending portion 421, and the first portion 43 and the second portion 44 can enclose to form a rectangular box. The cell component 2 includes a top wall, a bottom wall, a left side wall, a right side wall, a front side wall, and a rear side wall. The top wall and the bottom wall are arranged opposite to each other along the height direction of the cell component 2, the left side wall and the right side wall are arranged opposite to each other along the length direction of the cell component 2, and the front side wall and the rear side wall are arranged opposite to each other along the width direction of the cell component 2. The insulating film 4 covers the bottom wall, the left side wall, the right side wall, the front side wall, the rear side wall, and a part of the top wall of the cell component 2. The battery cell is divided along a center line of the battery cell, the first portion 43 covers the rear side wall, a part of the top wall, a part of the left side wall, a part of the right side wall, and a part of the bottom wall of the cell component 2; and the second portion 44 covers the front side wall, a part of the top wall, another part of the left side wall, another part of the right side wall, and another part of the bottom wall of the cell component 2. The film bodies 41 of the first portion 43 and the second portion 44 overlap with each other at the top wall, the bottom wall, the left side wall and the right side wall of the cell component 2.

It should be noted that the part of the left side wall, the part of the right side wall, the part of the bottom wall, the another part of the left side wall, the another part of the right side wall, and the another part of the bottom wall of the cell component 2 together form a complete bottom wall, a complete left side wall, and a complete right side wall, and the first portion 43 and the second portion 44 have overlapping portions at positions where the first portion 43 and the second portion 44 cover the bottom wall, the left side wall, and the right side wall.

In some embodiments, a conventional top cover structure includes positive electrode upper plastic, negative electrode upper plastic, lower plastic, an explosion-proof plate, an explosion-proof valve patch, a sealing ring, a bare aluminum sheet, a negative pole, a positive pole, an insulating sheet, and a connecting sheet.

The lower plastic is a bottom component of the top cover structure and configured to insulate part of the top cover structure from the cell component. Specifically, the lower plastic uses insulating materials such as pp and contacts the shell, to ensure that the internal circuit of the battery cell is insulated from the external circuit of, to prevent the battery cell from short circuiting.

The lower plastic is provided with a mounting position for the pole, and the positive pole and the negative pole that each have a cylindrical structure are installed to the lower plastic. The negative pole and the positive pole usually use materials with good conductivity. For example, the positive pole can use aluminum or aluminum alloy, and the negative pole can use copper or copper alloy, aluminum or aluminum alloy, etc. The positive pole and the negative pole have a same structure, and serve as an external interface of the battery cell to connect the internal tab of the battery cell with the external circuit.

The connecting sheet is configured to provide a reliable electrical connection to connect the tab of the cell component to bottoms of the positive and negative poles of the battery pack, and is usually made of materials with good conductivity, such as copper and its alloy, which have certain mechanical strength and can ensure that the current can pass smoothly.

The positive electrode upper plastic covers the top of the positive pole where the bare aluminum sheet is exposed, and is configured to fix the positive pole and conduct electricity. Specifically, the positive electrode upper plastic uses conductive materials such as conductive PPS. The above-mentioned conductive materials enable the positive electrode upper plastic to improve the conductivity between the positive pole and the internal circuit of the battery, and improve the output power and efficiency of the battery.

The negative electrode upper plastic covers the top of the negative pole where the bare aluminum sheet is exposed, and is configured to fix and insulate the negative pole. Specifically, the negative electrode upper plastic uses insulating materials such as insulating PPS. The above-mentioned insulating materials can prevent contact short circuits between the negative pole and the shell or other metal components, provide electrical isolation, improve the safety and stability of the battery cell, and avoid electrical failures caused by accidental contact.

The bare aluminum sheet is sleeved on the pole by welding (such as ultrasonic welding, laser welding, or resistance welding) to form a reliable electrical connection and provide structural support for the positive pole and the negative pole. The bare aluminum sheet has good thermal conductivity, which can help the battery cell dissipate heat and reduce the temperature of the battery pack.

The explosion-proof sheet and the explosion-proof valve patch are made of high-temperature resistant materials, and the bare aluminum sheet is provided with mounting positions for the explosion-proof sheet and the explosion-proof valve patch. The explosion-proof sheet and the explosion-proof valve patch are installed at the mounting positions and are stacked to be used together, to ensure that the internal pressure of the shell can be released in time when necessary to ensure the safety of the battery cell during the charging and discharging process.

The sealing ring is sleeved on an outer periphery of the positive and negative poles, and is usually made of elastic materials such as fluororubber. These materials have good sealing performance and aging resistance, and have good sealing performance, which can ensure that the inside of the battery cell is isolated from the external environment and prevent moisture from intruding.

Different from the conventional top cover structure, the top cover structure 1 provided in the embodiments of the present disclosure includes: a sealing ring 15, a support assembly, a bare aluminum sheet 12, a negative pole, a positive pole, an insulating sheet 17, and a connecting sheet 13.

The connecting sheet 13 is configured to provide a reliable electrical connection to connect tabs of the cell component 2 with bottoms of the positive and negative poles 11 of the battery pack, and is usually made of materials with good conductivity such as copper and its alloys, which has certain mechanical strength and can ensure that the current can pass smoothly.

The bare aluminum sheet 12 is sleeved on the pole 11 by welding (such as ultrasonic welding, laser welding, or resistance welding) to form a reliable electrical connection. Specifically, the bare aluminum sheet 12 is provided with a mounting hole 121, and the positive pole and the negative pole are inserted in the mounting hole 121 to provide structural support for the positive pole and the negative pole. The bare aluminum sheet 12 has good thermal conductivity, which can help the battery cell dissipate heat and reduce the temperature of the battery pack.

The connecting region 14 of the top cover structure 1 is arranged at the insulating sheet 17. The insulating sheet 17 is made of a material with good insulation performance, such as PE, PP, etc., and is sleeved on the outer periphery of the pole 11 and located between the bare aluminum sheet 12 and the connecting sheet 13 to provide insolation for the positive pole and the negative pole to prevent short circuits.

The sealing ring 15 is annular and is sleeved on an outer periphery of the positive and negative poles 11. The sealing ring 15 is inserted into the mounting hole 121 of the bare aluminum sheet 12 and abuts against the wall of the mounting hole 121, that is, the sealing ring 15 is located between the positive and negative poles 11 and the wall of the mounting hole 121. The sealing ring 15 is usually made of elastic materials such as fluororubber, which have good sealing performance and aging resistance, and have good sealing performance to ensure that the inside of the battery cell is isolated from the external environment and to prevent moisture from intruding.

It should be noted that at least part of the wall of the mounting hole 121 in this disclosure has an inclined surface. Specifically, along a height direction of the pole 11, a cross-sectional of an upper part of the mounting hole 121 has a shape of an inverted boss structure, and a cross-sectional of a lower part of the mounting hole 121 has a shape of a boss structure. It is understandable that the cross-sectional of the mounting hole 121 has a shape of an approximate “hourglass”. When the sealing ring 15 is installed in the mounting hole 121, a guiding effect of the inclined surface can make the sealing ring 15 to better fill in the mounting hole 121 after being deformed and fit the mounting hole tightly, thereby reducing a gap between the sealing ring 15 and the wall of the mounting hole 121 and walls of the positive and negative poles, thus improving the sealing effect of the sealing ring 15.

At the same time, the support assembly includes a first pressing block 161 and a second pressing block 162. Along a thickness direction of the sealing ring 15, the sealing ring 15 is arranged between the first pressing block 161 and the second pressing block 162. It is understandable that along the height direction of the positive and negative poles 11, the first pressing block 161 and the second pressing block 162 respectively abut against two sides of the sealing ring 15, and by applying an appropriate pressure, it is ensured that the sealing ring 15 is in close contact with the walls of the pole 11 and the mounting hole 121, thereby achieving good sealing performance. In the actual assembly process, the sealing ring 15 is first placed around the pole 11 and between the pole 11 and the mounting hole 121 of the bare aluminum sheet 12, and then is fixed in place by the first pressing block 161 and the second pressing block 162. At this time, the first pressing block 161 and the second pressing block 162 apply an appropriate pressure to ensure that the sealing ring 15 is deformed and filled in the mounting hole 121 and fits tightly, thereby achieving good sealing performance. The first pressing block 161 and the second pressing block 162 in this disclosure may be ceramic pressing blocks, and the second pressing block 162, serving as the lower part of the support assembly, can be provided with a corresponding engaging/locking/buckle-in structure according to the structures of the sealing ring 15, the bare aluminum sheet 12, the negative pole, the positive pole, the insulating sheet 17, and the connecting sheet 13, so that the assembly of the top cover assembly is more stable. For example, a protruding structure can be provided at the top of the second pressing block 162, and an engaging slot corresponding to the pole can be provided at the bottom of the second pressing block 162, which are not limited herein.

It can be understood that the sealing ring 15, the support assembly, the bare aluminum sheet 12, the negative pole, the positive pole, the insulating sheet 17, and the connecting sheet 13 are assembled to form the top cover structure 1 of the present disclosure, which jointly ensure a reliable electrical connection between the battery cell and the external circuit, and provide necessary structural support and protection.

In some embodiments of the present disclosure, the pole 11 includes a main body 111, a first bending portion 112, and a second bending portion 113. The main body 111 is a plate-like structure, and a length of the main body 111 is the length of the pole 11. The present disclosure does not limit the width of the plate-like structure, which can be selected according to the capacity of the battery cell.

As an optional technical solution of the present disclosure, a ratio of the length of the positive pole or the length of the negative pole to the length of the battery cell is greater than or equal to 10%. Optionally, the ratio of the length of the positive pole or the length of the negative pole to the length of the battery cell can range from 15% to 20%, 18 to 25%, or 21% to 27%, etc., and may be specifically 10%, 15%, 20%, 25%, 30%, 35% and 40%, etc., or other values within this range, which can be selected according to actual needs and not limited herein. In the embodiments of the present disclosure, the ratio of the length of the positive pole or the length of the negative pole to the length of the battery cell is within the above-mentioned range, the pole 11 has a relatively large size, leading to high mechanical strength, a lower contact resistance, and greater current carrying capacity, which can meet the production needs of a large-capacity battery cell. The pole 11 having a larger size has a better heat dissipation performance, which can ensure that the battery cell operates within a safe temperature range. It is understandable that if the ration of the length of the pole 11 to the length of the battery cell is too small, that is, the pole 11 has a relatively small size, the difficulties of welding and connecting are increased, and poor welding may lead to poor contact, affecting the electrical performance and reliability of the battery. Moreover, the pole 11 having a too small size has low mechanical strength, a high contact resistance, and low current carrying capacity. If the ratio of the length of the pole 11 to the length of the battery cell is too large, the overall weight of the battery will be increased, and the manufacturing cost of the battery will be increased. Preferably, the ratio of the length of the pole 11 to the length of the battery cell ranges from 10% to 30%.

As another optional technical solution of the present disclosure, the ratio of the total length of the positive pole and the negative pole to the length of the battery cell is greater than or equal to 10%. Optionally, the ratio of the total length of the positive pole and the negative pole to the length of the battery cell ranges from 13% to 17%, 18% to 25%, or 30% to 36%, etc., and may be specifically 10%, 15%, 20%, 25%, 30%, 35%, 40%, 45%, 55%, 60%, and 65%, etc., or other values within this range, which can be selected according to actual needs and not limited herein. In the present disclosure, the ratio of the total length of the positive pole and the negative pole to the length of the battery cell is within the above-mentioned range, the pole 11 is a relatively large size, leading to high mechanical strength, low contact resistance and great current carrying capacity, and can meet the production needs of large-capacity batteries. The pole 11 having a larger size has better heat dissipation performance, which can ensure that the battery cell operates within a safe temperature range. It is understandable that if the ratio of the length of the pole 11 to the length of the battery cell is too small, that is, the size of the pole 11 is too small, the difficulties of welding and connection are increased, and poor welding may lead to poor contact, affecting the electrical performance and reliability of the battery. The pole 11 having a small size has low mechanical strength, high contact resistance, and low current carrying capacity. If the ratio of the length of the pole 11 to the length of the battery cell is too large, the overall weight of the battery and the manufacturing cost of the battery are increased. Preferably, the ratio of the total length of the positive pole and the negative pole to the length of the battery cell ranges from 10% to 30%.

Preferably, along the length direction of the battery cell, the length of the pole 11 ranges from 10 mm to 100 mm. Optionally, the length of the pole 11 can range from 18 mm to 25 mm, 36 mm to 44 mm, or 27 mm to 65 mm, etc., specifically may be 10 mm, 20 mm, 30 mm, 40 mm, 50 mm, 60 mm, 70 mm, 80 mm, 90 mm, and 100 mm, etc., or other values within this range, which can be selected according to actual needs and not limited herein. It can be understood that the length of the pole 11 within the above-mentioned range has certain mechanical strength while having a low contact resistance and great current carrying capacity. The pole 11 having a larger size has a larger heat dissipation area, that is, better heat dissipation performance, which can ensure that the battery cell operates within a safe temperature range.

In some embodiments, along the height direction of the battery cell, the first bending portion 112 and the second bending portion 113 are respectively located at two sides of the mounting hole 121 of the bare aluminum sheet 12, and the first bending portion 112 and the second bending portion 113 each extend horizontally along the width direction of the battery cell. Along the width direction of the battery cell, the first bending portion 112 and the second bending portion 113 that are projected on a same straight line extend oppositely in the width direction of the battery cell, that is, the first bending portion 112, the main body 111, and the second bending portion 113 that are projected on a same straight line is a “Z”-shaped structure. At the same time, along the length direction of the battery cell, two adjacent first bending portions 112 bend oppositely in the width direction of the battery cell, and two adjacent second bending portions 113 bend oppositely in the width direction of the battery cell. It can be understood that, for the above-mentioned structure of the pole 11, the first bending portion 112 and the second bending portion 113 are staggered from one another in the length direction, in the width direction, and in the height direction of the battery cell, thereby achieving a better fixing effect with the connecting sheet 13 and the bare aluminum sheet 12.

Along the length direction of the battery cell, the width of the first bending portion 112 and the width of the second bending portion 113 each may range from 1 mm to 10 mm. Along the width direction of the battery cell, an extension length of the first bending portion 112 and an extension length of the second bending portion 113 each may range from 0.5 mm to 5 mm. Optionally, the width of the first bending portion 112 and the width of the second bending portion 113 each may range from 2 mm to 5 mm, 4 mm to 7 mm, 3 mm to 9 mm, etc., specifically may be 1 mm, 2 mm, 3 mm, 4 mm, 5 mm, 6 mm, 7 mm, 8 mm, 9 mm and 10 mm, etc. The extension length of the first bending portion 112 and the extension length of the second bending portion 113 each may range from 0.7 mm to 3 mm, 1 mm to 4 mm, 2.5 mm to 3.5 mm, etc., specifically may be 0.5 mm, 1 mm, 2 mm, 3 mm, 4 mm, and 5 mm, etc., or other values within this range, which can be selected according to actual needs and not limited herein.

Along the length direction of the battery cell, a space between adjacent first bending portions 112 and a space between adjacent second bending portions 113 may range from 0.17 mm to 3.4 mm. Optionally, the space between adjacent first bending portions 112 and the space between adjacent second bending portions 113 may range from 0.18 mm to 0.95 mm, 1.6 mm to 2.7 mm, 1 mm to 3 mm, etc., specifically may be 0.17 mm, 0.67 mm, 1.17 mm, 1.67 mm, 2.17 mm, 2.67 mm, 3.17 mm and 3.4 mm, etc., or other values within this range, which can be selected according to actual needs and not limited herein.

It can be understood that in the case where the widths and extension lengths of the first bending portion 112 and the second bending portion 113, and the space between adjacent first bending portions 112 and the space between adjacent second bending portions 113 are within the above-mentioned ranges, when the length of the pole 11 is constant, the number of the first extending portions 42 and the number of the second extending portions 42 can be ensured to enhance the connection stability between the second bending portion 113 and the connecting sheet 13, while reducing the contact resistance between the first bending portion 112 and the second bending portion 113.

In some embodiments of the present disclosure, the connecting sheet 13 connected to the second extending portion 42 is used to connect the cell component 2 inside the battery cell and the pole 11. During the charging and discharging process of the battery cell, the connecting sheet 13 can carry the current during the charging and discharging process of the battery cell, ensuring that the current can pass stably, thereby ensuring that the electric energy generated inside the battery cell can be stably output to the outside of the battery cell.

The connecting sheet 13 in the embodiments of the present disclosure is a rectangular sheet structure, which is provided with staggered first connecting holes 131 at a surface thereof. The distribution positions of the first connecting holes 131 correspond to the shapes of the second bending portions 113, so that the second bending portions 113 of the pole 11 can be engaged with, for example, buckled into the first connecting holes 131 when assembling the battery cell, and the second bending portions 113 do not protrude from the surface of the connecting sheet 13 away from the bare aluminum sheet 12. It can be understood that the design that the second bending portions 113 do not protrude from the surface of the connecting sheet 13 can reduce an influence of the second bending portion 113 on the connection stability between the connecting sheet 13 and the cell component 2, and the connection between the connecting sheet 13 and the cell component 2 is more stable, thereby reducing a risk of loosening or falling off causing by poor contact between the connecting sheet 13 and the cell component 2, and ensuring that the battery cell still maintains a good electrical connection under vibration or impact environment and extending the service life of the battery cell.

At the same time, compared with a conventional adapter sheet, the welding position 132 of the connecting sheet 13 having a rectangular sheet shape can be directly welded or connected to the tab of the cell component 2, therefore, it simplifies the connection process, there is no requirement for additional connectors or joints, and intermediate links in the installation process of the connecting sheet 13 can be reduced. Moreover, the connection distance between the tab and the connecting sheet 13 is shortened, thereby reducing the resistance loss during the current transmission process.

In some embodiments of the present disclosure, the battery pack also includes a bar 5, and the battery cell is connected to the external circuit through the bar 5, in this way, the battery cell is fixed, thereby ensuring the stable connection between the battery cell with other components during the packaging process, and also ensuring that the electric energy generated inside the battery cell can be output to the external circuit. During the charging and discharging process of the battery cell, the bar 5 can carry the current during the charging and discharging process of the battery cell, ensuring that the current can pass stably.

In the embodiments of the present disclosure, the bar 5 has a rectangular sheet structure, similar to the structure of the connecting sheet 13, and second connecting holes 51 staggered from one another are arranged at a surface of the bar 5. The distribution positions of the second connecting holes 51 correspond to the shapes of the first bending portions 112, so that the first bending portions 112 of the pole 11 can be engaged with, for example, buckled into the second connecting holes 51 when assembling the battery cell, and the first bending portions 112 do not protrude from the surface of the bar 5 away from the bare aluminum sheet 12.

It can be understood that the connecting sheet 13 and the second extending portion 42, the bar 5 and the first extending portion 42 in the embodiments of the present disclosure adopt the above-mentioned buckle-in connection method, which can ensure the connection stability between the pole 11, the connecting sheet 13, and the bar 5.

In some embodiments of the present disclosure, after the first bending portion 112 is buckled in the second connecting hole 51 of the bar 5 and the second bending portion 113 is buckled in the first connecting hole 131 of the connecting sheet 13, an edge of the first bending portion 112 abutting against the bar 5 can be welded to the bar 5, and an edge of the second bending portion 113 abutting against the connecting sheet 13 can be welded to the connecting sheet 13, thereby improving the connection stability between the first bending portion 112 and the bar 5 and the connection stability between the second bending portion 113 and the connecting sheet 13.

The present disclosure also provides a process for forming a battery cell, and the process includes a process for assembling a top cover structure 1. The process for assembling the top cover structure 1 includes steps S10, S20, and S30.

At step S10, a pole 11, a bare aluminum sheet 12, and a connecting sheet 13 are provided. The pole 11 includes a main body 111, first extending portions 42, and second extending portions 42. Along the height direction of the battery cell, the first extending portion 42 and the second extending portion 422 are respectively arranged at two ends of the main body 111. The bare aluminum sheet 12 is provided with a mounting hole 121, and the connecting sheet 13 is provided with staggered connecting holes.

At step S20, the main body 111 of the pole 11 is inserted into the mounting hole 121 of the bare aluminum sheet 12, and the first extending portions 42 are bent to form the first bending portions 112, and the second extending portions 42 are bent to form the second bending portions 113. The first bending portion 112 and the second bending portion 113 are bent oppositely in the width direction of the battery cell. Two adjacent first bending portions 112 arranged along the length direction of the battery cell are bent oppositely in the width direction of the battery cell, and two adjacent second bending portions 113 arranged along the length direction of the battery cell are bent oppositely in the width direction of the battery cell.

At step S30, the second bending portions 113 of the pole 11 are buckled into the first connecting holes 131 of the connecting sheet 13, and the second bending portions 113 do not protrude from a surface of the connecting sheet 13 away from the bare aluminum sheet 12.

At step S10, the first extending portions 42 and the second extending portions 42 are not bent yet, that is, the main body 111, the first extending portions 42, and the second extending portions 42 are located in a same plane, the pole 11 is a plate-like structure, the first extending portions 42 are arranged at intervals at a side of the main body 111 along the height direction, and the second extending portions 42 are arranged at intervals at another side of the main body 111 along the height direction.

At step S20, the pole 11 is a plate-like structure, and at least part of a wall surface of the mounting hole 121 is an inclined surface. The pole 11 can pass through the mounting hole 121 of the bare aluminum sheet 12, so that the bare aluminum sheet 12 is sleeved on an outer periphery of the main body 111. At the same time, an annular insulating sealing ring 15 is arranged between the outer wall surface of the main body 111 and the mounting hole 121. The sealing ring 15 abuts against the inclined surface where the mounting hole 121 is located, and a first pressing block 161 and a second pressing block 161 are arranged at two sides of the sealing ring 15 along the height direction of the pole 11, that is, the sealing ring 15, the first pressing block 161 and the second pressing block 162 are sleeved on the outer periphery of the pole 11, and are stacked along the height direction of the pole 11. The first pressing block 161 and the second pressing block 162 apply an appropriate pressure to make the sealing ring 15 fill the gap formed by the wall of the installation hole 121, the pole 11, the first pressing block 161, and the second pressing block 162, to ensure the close contact between the sealing ring 15, the pole 11, and the shell 3, so as to achieve good sealing performance of the sealing ring 15.

After the first pressing block 161 and the second pressing block 162 are installed, a force is applied to the first extending portion 42 and the second extending portion 42, so that the first extending portion 42 and the second extending portion 42 are bent to form the first bending portion 112 and the second bending portion 113. It can be understood that after the first bending portion 112 and the second bending portion 113 are formed, the first pressing block 161 and the second pressing block 162 can be further fixed to the sealing ring 15.

At step S30, the second bending portion 113 of the poles 11 are buckled in the first connecting holes 131 of the connecting sheet 13. This process includes: spatially aligning and buckling the bending structures formed by the second bending portions 113 with the first connecting holes 131 staggered from one another at the connecting sheet 13.

After step S30, the process further includes a step S40. The step S40 includes: welding the second bending portions 113 of the pole 11 with edges of the first connecting holes 131 of the connecting sheet 13, and welding the first bending portions 112 of the pole 11 with edges of the second connecting holes 51 of the bar 5. It can be understood that with the configuration that the second bending portions 113 and the connecting sheet 13 are fixed by welding and the first bending portions 112 and the bar 5 are fixed by welding, the connection stability between the first bending portions 112 and the bar 5 and the connection stability between the second bending portions 113 and the connecting sheet 13 can be improved.

After step S30, the assembly is obtained. Then, the positive electrode upper plastic, the negative electrode upper plastic, the lower plastic, the explosion-proof plate, the explosion-proof valve patch and the assembly are connected together to complete the assembly process of the top cover structure 1. It should be noted that the structure of the positive electrode upper plastic, the negative electrode upper plastic and other components can be adjusted according to the shape and size of the pole 11, which is not limited herein.

After step S30, a coating process of the insulating film 4 may be further included, and the coating process of the insulating film 4 includes steps S40, S50, and S60.

At step S40, the bare battery 2, the top cover structure 1, and the insulating film 4 are provided. The bare battery 2 includes a top wall, a bottom wall, a left wall, a right wall, a front side wall, and a rear side wall. The lower plastic of the top cover structure 1 is provided with a connecting region 14, and a distance between the connecting region 14 and a center of the top cover structure 1 is smaller than a distance between the edge of the top cover structure 1 and the center of the top cover structure 1. The battery also includes an insulating film 4, the insulating film 4 includes a first portion 43 and a second portion 44 that have a same structure, and the first portion 43 and the second portion 44 each are provided with a film body 41 and an extending portion 42.

At step S50, the first portion 43 and the second portion 44 wrap the cell component 2 along the width direction of the cell component 2. The film body 41 of the first portion 43 wraps the rear side wall, a part of the top wall, a part of the left side wall, a part of the right side wall, and a part of the bottom wall of the cell component 2. The film body 41 of the second portion 44 wraps the front side wall, a part of the top wall, another part of the left side wall, another part of the right side wall, and another part of the bottom wall of the cell component 2. A part of the film body 41 of the first portion 43 and a part of the film body 41 of the second portion 44 overlap with each other at the bottom wall, at the left side wall, and at the right side wall of the cell component 2.

At step S60, the extending portion 42 of the first portion 43 and the extending portion 42 of the second portion 44 are bent towards the center of the top surface of the cell component 2 along the length direction and along the width direction of the cell component 2, so that the extending portion 42 is located between the connecting region 14 and the top surface of the cell component 2, and the upper surface of the extending portion 42 is connected to the connecting region 14.

After step S60, a process for connecting the insulating film 4 with the connecting region 14 is further included, in which the extending portion 42 and the connecting region 14 of the top cover structure 1 are connected by hot melting, and then the top cover structure 1 and the shell 3 are welded. At this time, the insulating film 4 will not be squeezed into the gap to be welded between the shell 3 and the top cover structure 1, which can prevent the insulating film 4 from interfering the welding between the top cover structure 1 and the shell 3, reduce poor welding, ensure the sealing and electrical connection of the battery pack, and thus improve the working performance and safety of the battery pack.

After the above steps S40 to S60, the cell component 2 can be connected to the top cover structure 1, and the cell component 2 can be assembled into the shell 3 after the bottom of the cell component 2 is connected to the bottom support sheet 21, and the shell 3 and the top cover are welded to complete the assembly process of the battery cell.

The above describes in detail the structure, features and effects of the present disclosure based on the embodiments shown in the drawings. The above describes embodiments of the present disclosure, but the present disclosure is not limited to the scope of implementation shown in the drawings. Any changes made according to the concept of the present disclosure, or modifications to equivalent embodiments with equivalent changes, which still do not exceed the spirit covered by the description and drawings, should fall within the scope of the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A battery cell, comprising a top cover structure, wherein the top cover structure comprises:
a pole comprising a main body, first bending portions, and second bending portions, wherein the first bending portions and the second bending portions are respectively arranged at two sides of the main body along a height direction of the battery cell, and the first bending portions and the second bending portions each extend horizontally along a width direction of the battery cell; the first bending portion and the second bending portion that are projected on a same straight line along the width direction of the battery cell extend oppositely in the width direction of the battery cell; two adjacent first bending portions arranged along a length direction of the battery cell bend oppositely in the width direction of the battery cell, and two adjacent second bending portions arranged along the length direction of the battery cell bend oppositely in the width direction of the battery cell; and a ratio of a length of the pole to a length of the battery cell is greater than or equal to 10%;
a bare aluminum sheet provided with a mounting hole, wherein the main body of the pole is inserted in the mounting hole, and the first bending portions and the second bending portions are respectively located at two sides of the mounting hole along the height direction of the battery cell; and
a connecting sheet provided with first connecting holes staggered from one another, wherein the second bending portions of the pole are buckled in the first connecting holes, and the second bending portions do not protrude from a surface of the connecting sheet away from the bare aluminum sheet.

2. The battery cell according to claim 1, wherein the connecting sheet is of a rectangular sheet structure.

3. The battery cell according to claim 1, wherein the length of the pole ranges from 10 mm to 100 mm along the length direction of the battery cell.

4. The battery cell according to claim 1, wherein the first bending portions and the second bending portions each have a length ranging from 1 mm to 10mm along the length direction of the battery cell.

5. The battery cell according to claim 1, wherein the first bending portions and the second bending portions each have an extension length ranging from 0.5 mm to 5 mm along the width direction of the battery cell.

6. The battery cell according to claim 1, wherein, along the length direction of the battery cell, a space between two adjacent first bending portions ranges from 0.17 mm to 3.4 mm, and a space between two adjacent second bending portions ranges from 0.17 mm to 3.4 mm.

7. The battery cell according to claim 1, wherein the connecting sheet and the second bending portions are welded together after the second bending portions are buckled in the connecting sheet.

8. The battery cell according to claim 1, wherein the ratio of the length of the pole to the length of the battery cell is smaller than or equal to 30%.

9. The battery cell according to claim 1, wherein in each of the length direction of the battery cell, the width direction of the battery cell, and the height direction of the battery cell, the first bending portions and the second bending portions are staggered from one another.

10. The battery cell according to claim 1, further comprising:
a cell component;
a shell, wherein the top cover structure is connected to a top of the shell, the cell component is accommodated in the shell, and the top cover structure comprises a bottom surface having a connecting region, wherein a distance between the connecting region and a center of the bottom surface of the top cover structure is smaller than a distance between an edge of the top cover structure and the center of the bottom surface of the top cover structure; and
an insulating film, wherein the insulating film comprises a film body coated on a side wall and a bottom wall of the cell component, and extending portions formed by extending upwards from side walls of the film body, wherein the extending portions are bent towards a center of a top surface of the cell component along a length direction and a width direction of the cell component, and the extending portions are located between the connecting region and the top surface of the cell component along the height direction of the cell component, and an upper surface of the extending portions is connected to a lower surface of the connecting region.

11. The battery cell according to claim 10, wherein the film body and the extending portions are formed into one piece.

12. The battery cell according to claim 10, wherein the film body or the extending portions are formed by multiple film structures.

13. The battery cell according to claim 10,
wherein the extending portions comprises first extending portions arranged oppositely along the width direction of the battery cell and second extending portions arranged oppositely along the length direction of the battery cell; and
wherein the bottom surface of the top cover structure is provided with first regions arranged oppositely along the width direction of the battery cell and second regions arranged oppositely along the length direction of the battery cell; when installing the insulating film, the first extending portion is located between the first region and the top surface of the cell component, and the upper surface of the first extending portion is connected to the first region; the second extending portion is located between the second region and the top surface of the cell component, and an upper surface of the second extending portion is connected to the second region.

14. The battery cell according to claim 13, wherein the first region and the second region have an overlapping portion, and no insulating film is provided at the overlapping portion of the first region 141 and the second region 142.

15. The battery cell according to claim 13, wherein the first extending portions each have a width ranging from 2 mm to 8 mm, and the second extending portions each have a width ranging from 2 mm to 6 mm.

16. The battery cell according to claim 13, wherein the first region includes a first sub-region, the second region includes a second sub-region, the first sub-region overlaps with the second sub-region, the first extending portion is located between the top surface of the cell component and other sub-regions of the first region except the first sub-region, and the second extending portion is located between the top surface of the cell component and other sub-regions of the second region except the second sub-region.

17. The battery cell according to claim 10,
wherein the cell component comprises a top wall, a bottom wall, a left side wall, a right side wall, a front side wall, and a rear side wall, wherein the top wall and the bottom wall are opposite to each the along the height direction of the cell component, the left side wall and the right side wall are opposite to each other along the length direction of the cell component, and the front side wall and the rear side wall are opposite to each other along the width direction of the cell component; and the insulating film comprises a first portion and a second portion that have a same structure;
wherein the battery cell is divided along a center line of the battery cell, the first portion covers the rear side wall, a part of the top wall, a part of the left side wall, a part of the right side wall, and a part of the bottom wall of the cell component; the second portion covers the front side wall, a part of the top wall, another part of the left side wall, another part of the right side wall, and another part of the bottom wall of the cell component; and
the film body of the first portion and the film body of the second portion partially overlap with each other at the top wall, at the bottom wall, at the left side wall and at the right side wall of the cell component.

18. The battery cell according to claim 10,
wherein at least part of a wall surface of the mounting hole is an inclined surface;
the connecting sheet is connected to a bottom of the pole;
the top cover structure further comprises a sealing ring sleeved on an outer periphery of the pole and inserted into the mounting hole of the bare aluminum sheet to abut against the inclined surface where the mounting hole is located.

19. The battery cell according to claim 18, wherein the top cover structure further comprises a support assembly, wherein the support assembly comprises a first pressing block and a second pressing block, wherein the sealing ring is arranged between the first pressing block and the second pressing block along a thickness direction of the sealing ring.

20. The battery cell according to claim 1, wherein along a height direction of the pole, a cross-sectional of an upper part of the mounting hole has a shape of an inverted boss structure, and a cross-sectional of a lower part of the mounting hole has a shape of a boss structure, in such a manner that a cross-sectional of the mounting hole has a shape of an approximate “hourglass”.
